(19) United States
(12) Patent Application Publication
(10) Pub. No.: US 2009/0006596 A1
(43) Pub. Date: Jan. 1, 2009

(54) Dynamic address redemption and routing in ZigBee networks

(76) Inventors: Veluchamy Dinakaran, Bangalore (IN); Murukanandam K P, Bangalore (IN)

Correspondence Address: LeMOINE PATENT SERVICES, PLLC, C/O INTELLEVATE, P. O. BOX 52050, MINNEAPOLIS, MN, 55402, US

(21) Appl. No.: 11/823,234

(22) Filed: Jun. 27, 2007

(51) Int. Cl. G06F 15/173

(52) U.S. Cl. 709/223

(57) ABSTRACT

Dynamic address redemption and reallocation is performed in a ZigBee network. When a router node attempts to join a parent with no available address space, the parent requests available address space from child router nodes and possibly from the entire network. If available address space can be found, it is redeemed and reallocated to the router node wishing to join the network. A lookup table may be maintained at all nodes to track changes in address allocation.

### FIELD

The present invention relates generally to Wireless Personal Area Networks (WPANs), and more specifically to ZigBee wireless networks.

### BACKGROUND

ZigBee networks are low power, low rate wireless personal area networks(LR-WPAN) designed for sensor networks for exchanging control information. As of this writing, a ZigBee specification exists as ZigBee Specification Document 053474r13 (Dec. 1, 2006), published by the ZigBee alliance of San Ramon, Calif.

Within ZigBee networks, nodes can be linked in a “tree” structure where most nodes have a “parent node” above them in the tree, and may or may not have one or more “child nodes” below them in the tree. This “tree” structure is the basis for Hierarchical Routing in these networks. Nodes capable of having child nodes are referred to herein as “router-capable nodes” in part because they can route communications traffic to/from child nodes. Nodes not capable of having child nodes are referred to as “end nodes” and do not route traffic.

Each router node has a static address space assigned to it. As child nodes join the network under router-capable parent nodes, the router-capable parent nodes assign addresses from the static address space. If no addresses are available, the router-capable node refuses the connection. This may be an undesirable result under certain scenarios. For example, mobile nodes may operate in environments (e.g. hospitals) where a certain quality of service is desired or even required.

### BRIEF DESCRIPTION OF THE DRAWINGS

FIG. 1 shows a network diagram for a ZigBee network in accordance with various embodiments of the present invention;

FIG. 2 shows a child lookup table in accordance with various embodiments of the present invention;

FIG. 3 shows a flowchart in accordance with various embodiments of the present invention; and

FIG. 4 shows a diagram of an electronic system in accordance with various embodiments of the present invention.

### DESCRIPTION OF EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

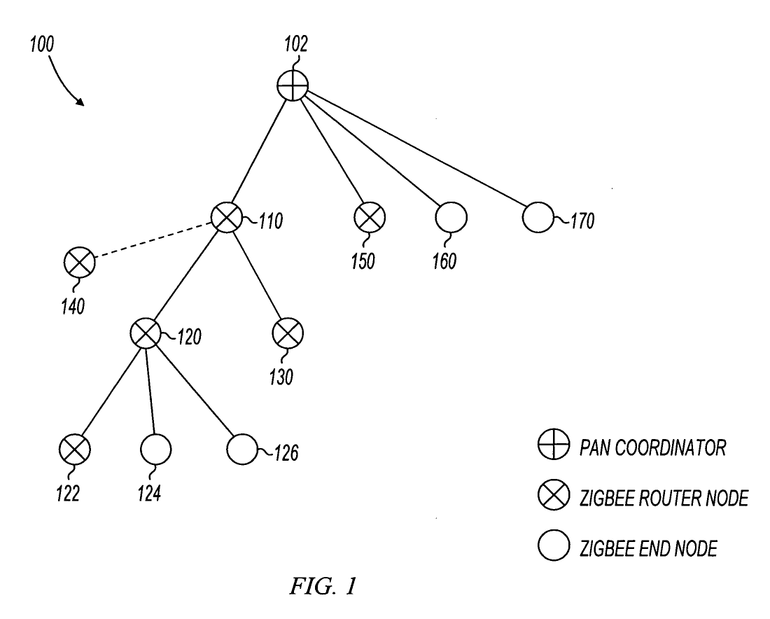

FIG. 1 shows a network diagram for a ZigBee network in accordance with various embodiments of the present invention. ZigBee network 100 includes nodes 102, 110, 120, 122, 124, 126, 130, 150, 160, and 170. Node 140 is shown attempting to join network 100. This process is described further below. The network nodes shown in FIG. 1 may be either a “router-capable parent node” or a “child node”. For example, the nodes may be sensors, asset tags, or any other device useful in a home, commercial, or industrial application. Oftentimes these types of network nodes are referred to as “motes.”

Network node 102 is referred to as a PAN coordinator. In the ZigBee System, the PAN coordinator initiates the construction of the wireless network, and assigns parameters for network operations. PAN coordinator 102 is a parent to router-capable nodes 110 and 150, and is also a parent to end nodes 160 and 170. Router capable node 150 is a child to PAN coordinator 102 and although capable, is not a parent to any child nodes. Router-capable node 110 is a child of PAN coordinator 102, and is a parent to router-capable nodes 120 and 130. Router-capable node 120 is a parent to router-capable node 122 and end nodes 122 and 126. Router-capable nodes 122 and 130 have no children.

ZigBee networks are statically configured with parameters such as the maximum number of children (Cm), the maximum depth in the network (Lm), and the maximum number of routers a parent may have as children (Rm). As per the ZigBee Specification, the size of the address sub-block statically assigned to each router-capable node at a depth “d” is given by the formula:

$${C}_{skip ( d )} = \{ \begin{matrix}1 + {C}_{m \cdot } ( {L}_{m} - d - 1 ) , if {R}_{m} = 1 \\ \frac{1 + {C}_{m} - {R}_{m} - {C}_{m \cdot } {R}_{m}^{{L}_{m} - d - 1}}{1 - {R}_{m}} , otherwise\end{matrix} \qquad ( 1 )$$

In the example network shown in FIG. 1, Cm=4, Rm=2, and Lm=16. Accordingly, each router-capable node is statically allocated enough address space to accommodate a maximum of two router-capable children.

In some embodiments, a common usage pattern will include router-capable nodes leaving one parent and joining another as a child. For example, in a hospital scenario, sensor networks may be attached to patients and other units that may be mobile. Also for example, a network of sensors may be attached to a mobile assembly units on a factory floor. In such cases one or more nodes will hop from one parent to join a new parent.

In the example of FIG. 1, node 140 is a router-capable node that has left a previous association and wants to become a child of node 110, and node 110 is the only node in the radio vicinity of the node 140. In network 100, Rm=2 which means that each router-capable node has only enough statically allocated address space to accept two router-capable child nodes. Under the ZigBee Specification as currently written, node 140 will be refused connection and will not be allowed to join the network, because node 110 already has two router-capable children. Even though there may be unused address space elsewhere in the network, node 140 is denied the connection to join at node 110, because node 110 lacks sufficient address space.

Various embodiments of the present invention redeem unused address space from other portions of the network tree and allocate it where it is needed. For example in FIG. 1, router-capable nodes 120, 122, 130, and 150 have unused statically allocated address space because each has fewer than two router-capable children.

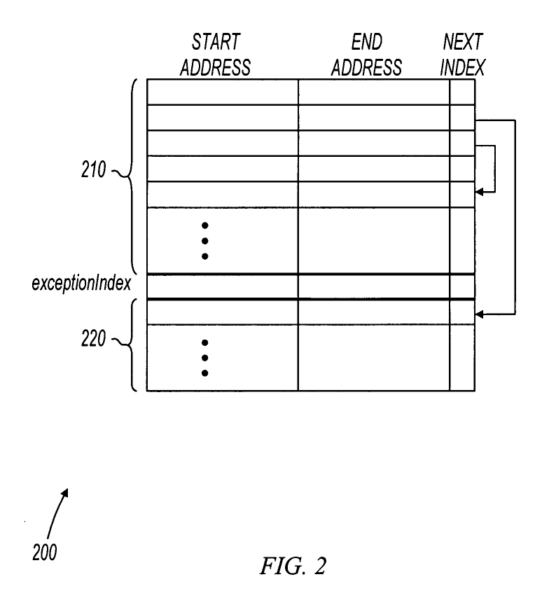

Various embodiments of the present invention also maintain lookup tables at each node to keep track of changes in the static address allocation. For example, if address space formerly allocated to node 122 is dynamically redeemed and reallocated to node 140, a lookup table is maintained on node 120 and node 110 to keep track of the modified address allocation. An example lookup table embodiment is described below with reference to FIG. 2.

### Address Redemption and Allocation

In operation, node 140 may send a request to node 110 to join the network as a child of node 110. The request may include:

MAC ID: This field gives the unique MAC address of the node that originates the request (node 140 in this example).

Priority: This field may be used to assign a priority level to the request. For example, in a hospital environment, a new node may be critical to patient monitoring and cannot simply be denied a connection. A high priority may be assigned in this situation.

Number of addresses required: This field is an optional field. This is useful in scenarios where a parent node of a sub-tree moves to a new parent, and it wants its sub-tree to remain intact. So, it can specify the total number of addresses needed for this subtree as a whole.

Node 110 may respond to this request in one of at least three different ways in accordance with embodiments of the present invention. The three possible responses are now described as Cases 1-3.

### Case 1: Prospective Parent Node has Address Space to Satisfy the Request

If the prospective parent node (node 110 in this example), has address space to accommodate another router-capable child, then the address space can be allocated to it using the Cskip value as given in equation (1) above. Note that this is not the case in the example of FIG. 1 because node 110 already has the maximum number of router-capable children. This would be the case, however, if node 140 was trying to join node 120, 122, 130, or 150.

### Case 2: Prospective Parent Node Searches for Space in its Own Existing Sub-Tree

If case 1 is not satisfied, then the prospective parent node can send a request to its existing router-capable children asking for a report of their unused address space. In the example of FIG. 1, node 110 will send requests to nodes 120 and 130 asking for reports on available address space. Each router-capable child node will then in turn request the same report of their router capable children. This repeats until requests are delivered to all router-capable children in the subtree. Each router-capable child node responds to its parent with a report of available address space. The result is the prospective parent node receiving a report of all unused address space in the subtree below it. In the example of FIG. 1, this corresponds to node 110 receiving information describing the available free address space in the subtree of node 120, and the available address space in the subtree of node 130.

If there is free address space available in one or more subtrees, then the prospective parent node determines which addresses to dynamically redeem and reallocate to the new child node. For example in FIG. 1, the request from node 140 is for a number of addresses “a”. Also suppose that nodes 120 and 130 returned “b” and “c” respectively, as their unused address space in their subtrees.

Scenario-1: a<b and a<c

In this scenario node 110 may redeem sufficient address space from either subtree. Node 110 may select one over the other based on the total number of address reconfiguration needed in response to the dynamic redemption.

Scenario-2: (a<b and a>c) or (a>b and a<c)

In this scenario node 110 will redeem the address space from the subtree with the larger set of unused address space.

Scenario-3: a>b and a>c but a<(b+c)

In this scenario, node 110, redeems and reallocates ‘a’ addresses from the combined free space of (b+c) and reconfigures both the subtrees with new addresses.

Scenario-4: a>b and a>c and a>(b+c)

In this scenario, the combined subtrees do not have sufficient unused address space to accommodate the request made by node 140. If so, node 110 may then forward the request for unused address space to its parent node 102. This corresponds to case 3, described next.

### Case 3: Prospective Parent Node Searches for Space Through its Parent

If case 2 cannot satisfy the request, then the prospective parent node can send a request to its parent node asking for a report of unused address space. The parent node can forward the request all the way up the tree to the PAN coordinator. At each level of the tree, subtrees can be searched in the manner described above under Case 2. In the example of FIG. 1, node 110 will send a request to node 102 for a report on available free address space. Node 102 may then send requests down other subtrees (in this example, to node 150) and report available free address space back to node 110. This is all done with minimal reconfigurations to the network.

If any of the above cases succeed in allocating the number addresses requested, then node 140 may join the network as a child of node 110. In some embodiments, node 140 may have a subtree attached to it, and in which case, the entire subtree may be attached with minimal reconfiguration when node 140 is allowed to join the network.

In some embodiments, a unique tuple with a request ID is maintained and tracked at the prospective parent node. A time-to-live (TTL) value may also be stored at the prospective parent node or any ancestor handling such a request until the reply comes. This can keep requests from being stored indefinitely.

This mechanism of address redemption from statically allocated Cskip values (as given by equation 1), causes a skew in the network and hence the network routing. To accommodate the skew in the network and routing, a child look up table is maintained at each node. The child look up table maintains the list of addresses that a node's children can handle.

### Look Up Table and Routing

FIG. 2 shows a child lookup table in accordance with various embodiments of the present invention. Table 200 is maintained in each router-capable node. Start addresses and end addresses are maintained for allocated address blocks. Further, a portion 210 of table 200 tracks addresses allocated for nodes joining as immediate children to this parent before reaching the limit imposed by the initial static address allocation. And a portion numbered 220 of table 200 tracks addresses allocated for new nodes joining as immediate children to this parent after reaching the limit imposed by the initial static address allocation.

Child lookup table 200 is provided as an example of how to track deviations from the static address allocation scheme. Any mechanism may be used to track these deviations without departing from the scope of the present invention.

The following pseudo-code provides an example algorithm for routing communications through a ZigBee network having dynamic address redemption and allocation.

### i) Data-Structure

Data-structure stored in each node that maintains the attribute information of each node.

```
Struct nodeAttributeStruct_t
{
    address;
    maxChildAddr;
    maxIndex;
    exceptionIndex;
}myNodeAttribute;
```

### ii) Routing Algorithm

On receiving a packet:

```
if the address of the incoming packet is that the node's own address
then
    consume the packet
    exit
endif
```

/* Check whether it belongs to some sibling tree of the present node */

```
if the incoming packet address is less than present node's address
or the address is greater than the address range managed by the present
node
then
  forward the packet to the present node's parent
  exit
endif
```

/* Normal routing parameters checked for. So the destination node for the present packet is a migrated node Since the address allocation is in Arithmetic Progression (i.e., addresses will be a, a+Cskip, a+2*Cskip and so on). We can use the indexed approach for search at the first instance. */
Calculate the index to use in the child lookup table using the formula

index=(packet.address−myNodeAttribute.address)/Cskip+1;

```
if index is greater than the present node's maximum index, then assign
it the default exceptionIndex
do
{
  Traverse to the top from the given index and find the index in which the
packet address fits in range of the index's start and end addresses
  index = child lookup table's current_entry.nextIndex
} while(index!=NULL);
if (index != NULL)
then
    Send the packet to the node with the address
“childLkTable[index].startAddress”
else
    Log(“Erroneous packet”);
    exit
endif
```

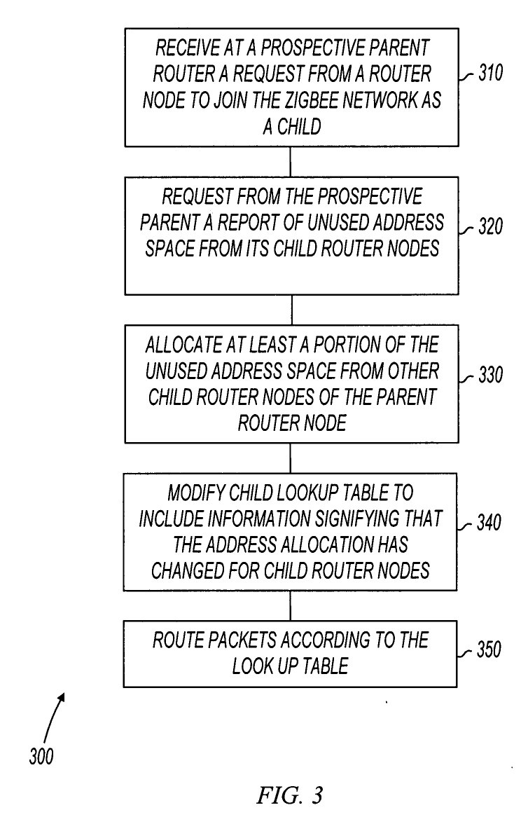

FIG. 3 shows a flowchart in accordance with various embodiments of the present invention. In some embodiments, method 300, or portions thereof, is performed by a parent router node in a ZigBee network. In other embodiments, method 300 is performed by an integrated circuit or an electronic system. Method 300 is not limited by the particular type of apparatus performing the method. The various actions in method 300 may be performed in the order presented, or may be performed in a different order. Further, in some embodiments, some actions listed in FIG. 3 are omitted from method 300.

Method 300 is shown beginning with block 310 in which a request to join a ZigBee network made by a requesting device is received at a parent router node. In some embodiments, the request may include a MAC ID, a priority field, and a number of addresses requested. For example, the requesting device may be a router-capable node that is the root of a subtree. The join request corresponds to a request to graft the subtree to the prospective parent router node when the requesting node becomes the child node of the parent. The number of addresses requested may correspond to the number of nodes in the subtree to be grafted, or may correspond to the number of router capable nodes in the subtree.

At 320, the parent node requests a report of unused address space from other child router nodes. This may occur when the parent node does not have enough statically assigned addresses available to satisfy the request made by the requesting device. In response to the request, other child nodes will report any available free address space. In some embodiments, the parent node also requests a report of unused address space elsewhere in the ZigBee network by sending a request to it's own parent.

At 330, the parent node redeems and reallocates at least a portion of the unused address space reported. By redeeming address space from elsewhere in the network, the parent node can allow the requesting node to join the network in situations where it might otherwise be denied service.

At 340, the child lookup table is modified to include information signifying that the address allocation has changed. An example look up table is described above with reference to FIG. 2. In some embodiments, lookup tables are maintained in every router-capable node so that each router-capable node has information to aid in routing packets. At 350, the packets are routed in accordance with the look up table.

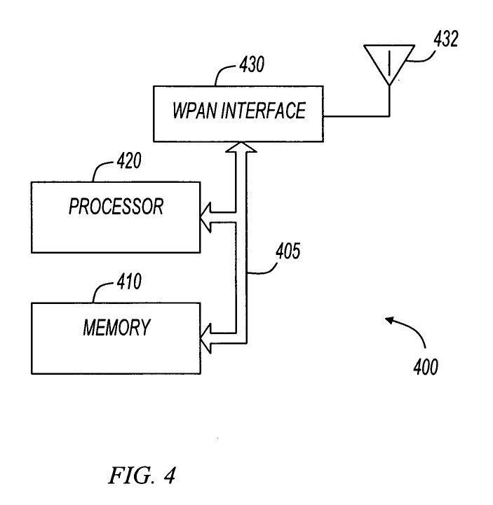

FIG. 4 shows a system diagram in accordance with various embodiments of the present invention. Electronic system 400 includes memory 410, processor 420, wireless personal area network (WPAN) interface 430, antenna 432, and bus 405. System 400 may be any device capable of joining a ZigBee network. For example, system 400 may be a mote for use in a commercial or industrial environment. Further, system 400 may be a sensor in a hospital environment. In some embodiments, system 400 may function as a router-capable node such as node 110 or 140 in a ZigBee network.

Memory 410 represents an article that includes a machine readable medium. For example, memory 410 represents any one or more of the following: a hard disk, a floppy disk, random access memory (RAM), read only memory (ROM), flash memory, or any other type of article that includes a medium readable by processor 420. Memory 410 can store instructions for performing the execution of the various method embodiments of the present invention.

In operation, processor 420 reads instructions and data from memory 410 and performs actions in response thereto. For example, processor 420 may access instructions from memory 410 and communicate with WPAN interface 430 using bus 405. WPAN interface 430 may receive data from processor 420 and transmit it to other devices such as other nodes in network 100 (FIG. 1). WPAN interface 430 may also receive data from various other devices and provide it to processor 420.

Antenna 432 may include an antenna of any type. For example, antenna 432 may include a single directional antenna or an omni-directional antenna. For example, in some embodiments, antenna 432 may include a single omni-directional antenna such as a quarter wave antenna. Also for example, in some embodiments, antenna 432 may include a single directional antenna such as a patch antenna. In still further embodiments, antenna 432 may include multiple physical antennas.

System 400 may include many components in addition to those shown in FIG. 4. For example, system 400 may include sensor circuitry for a commercial or industrial application. In general, system 400 may include any hardware or software that may be useful. For simplicity and clarity, system 400 is shown in FIG. 4 with less than all possible components. The various embodiments of the present invention are not meant to be limited in this respect.

Although the various elements of system 400 are shown separate in FIG. 4, embodiments exist that combine the circuitry of processor 420, memory 410, and all or a portion of WPAN interface 430 in a single integrated circuit. For example, processor 420 and memory 410 may be combined together on an integrated circuit die. In some embodiments, the various elements of system 400 may be separately packaged and mounted on a common circuit board. In other embodiments, the various elements are separate integrated circuit die packaged together, such as in a multi-chip module, and in still further embodiments, various elements are on the same integrated circuit die.

Although the present invention has been described in conjunction with certain embodiments, it is to be understood that modifications and variations may be resorted to without departing from the spirit and scope of the invention as those skilled in the art readily understand. Such modifications and variations are considered to be within the scope of the invention and the appended claims.

What is claimed is:

1. A method comprising:
receiving, at a parent router node in a ZigBee network, a request from a requesting device to join the ZigBee network as a child router node;
requesting a report of unused address space from other child router nodes of the parent router node; and
allocating at least a portion of the unused address space to the requesting device.

2. The method of claim 1 wherein receiving a request comprises receiving a request for a number of addresses needed by the requesting device.

3. The method of claim 2 wherein requesting a report of unused address space comprises requesting a report from a plurality of child router nodes.

4. The method of claim 2 wherein allocating comprises allocating unused address space reported from a single child router node when the single child router node reports unused address space greater than the number of addresses needed.

5. The method of claim 2 wherein allocating comprises allocating unused address space reported from a plurality of child router nodes when not enough unused address space is reported from any one of the plurality of child router nodes.

6. The method of claim 1 further comprising modifying a lookup table to include information signifying that the address allocation has changed for the child router nodes.

7. The method of claim 6 further comprising routing packets according to the lookup table.

8. The method of claim 1 further comprising requesting a report of unused address space from a parent of the parent router node.

9. An apparatus having a machine readable medium with instructions stored thereon that when accessed result in the machine:
requesting, by a parent node in a ZigBee network, a report of unused address space from child router nodes of the parent node;
allocating the unused address space to a new child router node of the parent node; and
maintaining a child address lookup table to keep track of address allocations for each child node of the parent node.

10. The apparatus of claim 9 wherein the instructions when accessed further result in the machine receiving a join request from the new child router node.

11. The apparatus of claim 10 wherein the join request includes a request for a number of addresses.

12. The apparatus of claim 11 wherein allocating comprises allocating unused address space from one child router node when possible.

13. The apparatus of claim 11 wherein allocating comprises aggregating unused address space multiple child router nodes when necessary to satisfy the request for a number of addresses.

14. The apparatus of claim 9 wherein the instructions when accessed further result in the machine routing packets in accordance with the child address lookup table.
